(19) United States
(12) Patent Application Publication
(10) Pub. No.: US 2023/0410455 A1
(43) Pub. Date: Dec. 21, 2023

(54) IMAGE GENERATION APPARATUS, IMAGE GENERATION SYSTEM, AND IMAGE GENERATION METHOD

(71) Applicant: HITACHI, LTD., Tokyo (JP)

(72) Inventors: Kazuyuki TAJIMA, Tokyo (JP); Keiichi MITANI, Tokyo (JP); Yusuke NAKAMURA, Tokyo (JP)

(21) Appl. No.: 18/131,902

(22) Filed: Apr. 7, 2023

(30) Foreign Application Priority Data
Jun. 20, 2022 (JP) 2022-098586

(51) Int. Cl. G06V 10/24; G06T 5/50; G06T 7/20

(52) U.S. Cl. CPC G06V 10/24; G06T 5/50; G06T 7/20; G06T 2207/20221

(57) ABSTRACT

An object of the invention is to provide a technique of performing alignment with high accuracy between a plurality of sensors even when a visual field overlapping region at the time of installation of the sensors is small in a case of imaging a subject using the plurality of sensors. An integrated image generation apparatus according to the invention generates a first pseudo visual field image that is able to be acquired by a first sensor in a first pseudo visual field generated by moving a relative position between the subject and the first sensor, and performs the alignment between the first pseudo visual field image and a second sensor image.

### CROSS-REFERENCE TO RELATED APPLICATION

The present application claims priority from Japanese application JP2022-098586, filed on Jun. 20, 2022, the contents of which is hereby incorporated by reference into this application.

### BACKGROUND OF THE INVENTION

### 1. Field of the Invention

The present invention relates to a technique of generating an image of a subject acquired by a sensor.

### 2. Description of Related Art

In order to install a plurality of sensors in a space and capture an image of a subject or to generate a two-dimensional or three-dimensional spatial map, alignment (adjustment for unifying a coordinate system) is required between imaging apparatuses. For example, when installation positions and orientations of the imaging apparatuses are fixed in a facility such as a venue, an installation position and an orientation of each imaging apparatus can be used as hyper parameters by appropriately installing the imaging apparatus, and alignment is unnecessary. However, when a disaster such as an earthquake or a refurbishment occurs and a change is generated from an initial installation position or an initial orientation, alignment is required again.

In a work site where spatial information such as terrain changes from moment to moment or in a construction site where building information modeling (BIM) data of a building is acquired in real time, an imaging apparatus may be attached to a robot that autonomously travels. In such a case, since the imaging apparatus has a high degree of freedom (freely move and change the orientation), alignment is required to be performed at high speed.

JP2014-164363A describes a technique related to alignment between images. An object of JP2014-164363A is that “a plurality of captured images are aligned by a marker, and a composite image with which the marker does not interfere is generated”, and this document describes a technique in which “a multi-camera imaging apparatus 1 includes: a plurality of cameras 2 that capture images of a plurality of imaging regions 6 adjacent to each other and overlapping each other; a plurality of laser devices 3 that apply a marker to each of common imaging regions 61-1 and 61-2 in which imaging regions 6-1 to 6-3 overlap each other; an imaging control unit 41 that controls the cameras 2 and the laser devices 3 and acquires a markerless image group to which the marker is not applied and a marker-applied image group to which the marker is applied; an invisible light image processing unit 42 that calculates a correction parameter as information on an inclination, a size, and alignment between the imaging regions 6 based on the marker-applied image group; and a visible light image processing unit 43 that generates a composite image by compositing the markerless image group based on the correction parameter” (see Abstract).

JP2013-021706A describes a technique related to alignment of frame images as a technique related to the invention. An object of JP2013-021706A is to “provide an imaging apparatus capable of easily recognizing that alignment of frame images fails when a visual field during imaging is displayed as a moving image at an appropriate position on a mosaic image”, and this document describes a technique in which “the imaging apparatus includes: a mosaic image generation unit that bonds a plurality of still images captured by a camera and generates a mosaic image; a feature data extraction unit that extracts feature data based on the frame images and the mosaic image; and a relative position determination unit that determines a relative position between the frame images and the mosaic image by comparing the feature data. The relative position determination unit determines the relative position based on feature data of each frame image acquired after determination of the relative position between the mosaic image and the frame images fails and feature data of a reference image obtained by using an image finally connected to the mosaic image as the reference image” (see Abstract).

### SUMMARY OF THE INVENTION

JP2014-164363A describes a method for aligning camera images by irradiating a visual field overlapping region of a plurality of cameras with a marker using a laser and acquiring a composite image without a marker by using a difference in a wavelength of the laser. In this technique, it is necessary to correctly irradiate the visual field overlapping region of the plurality of cameras with the marker for alignment. Further, when the overlapping region is small, the alignment may not be correctly performed even when the marker is used.

The invention has been made in view of the above problems, and an object of the invention is to provide a technique of performing alignment with high accuracy between a plurality of sensors even when a visual field overlapping region at the time of installation of the sensors is small in a case of imaging a subject using the plurality of sensors.

An integrated image generation apparatus according to the invention generates a first pseudo visual field image that is able to be acquired by a first sensor in a first pseudo visual field generated by moving a relative position between a subject and the first sensor, and performs alignment between the first pseudo visual field image and a second sensor image.

According to the integrated image generation apparatus of the invention, when an image of the subject is captured using a plurality of sensors, it is possible to perform the alignment with high accuracy between the plurality of sensors even when a visual field overlapping region at the time of installation of the sensors is small.

### BRIEF DESCRIPTION OF THE DRAWINGS

FIG. 1 is a basic configuration diagram of an integrated image generation apparatus according to a first embodiment;

FIG. 2 is a functional block diagram of the integrated image generation apparatus;

FIG. 3 is a flowchart illustrating a processing procedure performed by the integrated image generation apparatus;

FIG. 4 is a diagram illustrating a procedure in which a first pseudo visual field generation unit generates a pseudo visual field;

FIG. 5 illustrates image data acquired in a first visual field without using the pseudo visual field, image data acquired in a second visual field, and an overlapping region between the image data;

FIG. 6 illustrates image data acquired using the pseudo visual field as illustrated in FIG. 4, the image data acquired in the second visual field, and an overlapping region between the image data;

FIG. 7 is a schematic diagram illustrating a relationship between a visual field overlapping region ratio and an alignment success rate;

FIG. 8 is a configuration diagram illustrating a method for generating a pseudo visual field according to a second embodiment;

FIG. 9 illustrates an example of data of a subject acquired in previous and next ±2 frames when a time at which the subject passes through a center of the first visual field is set as t;

FIG. 10 is a functional block diagram of the integrated image generation apparatus according to a third embodiment;

FIG. 11 is a flowchart illustrating a processing procedure performed by the integrated image generation apparatus according to the third embodiment; and

FIG. 12 is a flowchart illustrating processing performed by the integrated image generation apparatus according to a fourth embodiment.

### DESCRIPTION OF EMBODIMENTS

Hereinafter, a description may be divided into a plurality of sections or embodiments if necessary for convenience. Unless otherwise specified, these sections or embodiments are not independent of each other, and in a relationship in which one section or embodiment is a modification, a detailed description, a supplementary description, or the like of a part or all of another section or embodiment.

Further, in the following embodiments, when the number and the like (including the number of pieces, numerical values, amounts, ranges, and the like) of elements are mentioned, these parameters are not limited to specific numbers and may be equal to or greater than the specific numbers or equal to or smaller than the specific numbers, unless otherwise specified and unless the specific numbers are clearly limited to specific numbers in principle.

Further, in the following embodiments, it is needless to say that elements (including element steps and the like) are not necessarily essential unless otherwise specified and unless the elements are clearly considered as essential in principle.

Similarly, in the following embodiments, when shapes, positional relationships, or the like of the elements or the like are mentioned, substantially approximate and similar shapes or the like are included unless otherwise specified and unless clearly excluded in principle. The same applies to the above numerical values and ranges.

In all the drawings for describing the embodiments, the same members are denoted by the same reference numerals in principle, and repetitive descriptions thereof are omitted.

### First Embodiment: Basic Configuration

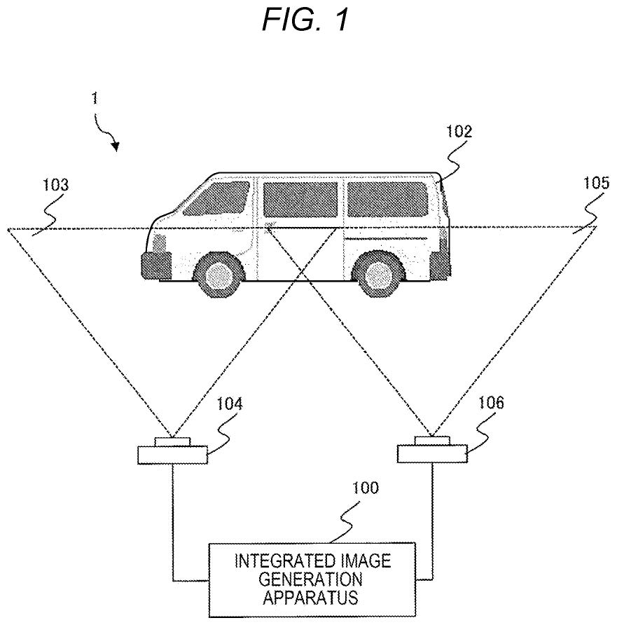

FIG. 1 is a basic configuration diagram of an image generation system 1 including an integrated image generation apparatus 100 according to a first embodiment of the invention. A first sensor 104 has a first visual field 103, and a second sensor 106 has a second visual field 105. Each sensor is installed to capture an image of a subject 102. The integrated image generation apparatus 100 acquires measurement data acquired by the sensors. The first sensor 104 and the second sensor 106 may be capable of acquiring a color image or a monochrome image of an imaging object, or may be capable of acquiring distance information as an image, and the image can be treated as an image including any or all of the information. The integrated image generation apparatus 100 composites information acquired from the first sensor 104 and the second sensor 106 and generates one integrated image.

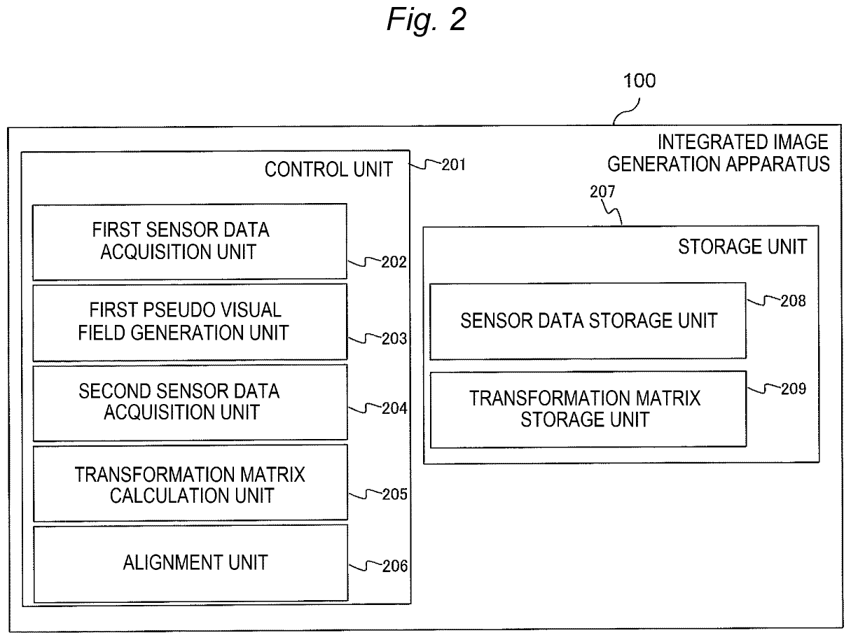

FIG. 2 is a functional block diagram of the integrated image generation apparatus 100. The integrated image generation apparatus 100 includes a control unit 201 and a storage unit 207. The control unit 201 further includes the following: a first sensor data acquisition unit 202 that acquires information from the first sensor 104; a first pseudo visual field generation unit 203 that generates a pseudo visual field of first sensor data based on data acquired by the first sensor data acquisition unit 202; a second sensor data acquisition unit 204 that acquires information from the second sensor 106; a transformation matrix calculation unit 205 that calculates a transformation matrix for use in performing alignment between the pseudo visual field generated by the first pseudo visual field generation unit 203 and the data acquired by the second sensor data acquisition unit 204; and an alignment unit 206 that performs alignment between the data acquired by the first sensor data acquisition unit 202 and the data acquired by the second sensor data acquisition unit 204 using the transformation matrix calculated by the transformation matrix calculation unit 205. The storage unit 207 includes the following: a sensor data storage unit 208 that stores the measurement data acquired by the first sensor 104 and the second sensor 106; and a transformation matrix storage unit 209 that stores the transformation matrix calculated by the transformation matrix calculation unit 205.

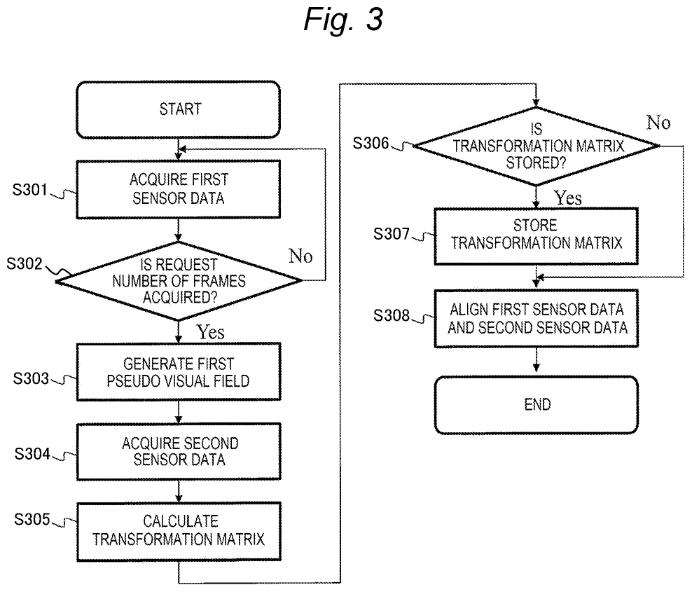

FIG. 3 is a flowchart illustrating a processing procedure performed by the integrated image generation apparatus 100. In step 301, the first sensor data acquisition unit 202 first acquires a frame of the first sensor data from the first sensor 104. Thereafter, since sensor data for a predetermined number of frames is required to generate the pseudo visual field, in step 302, the first sensor data acquisition unit 202 determines whether the number of frames of the acquired first sensor data reaches a request number of frames, stores the first sensor data in the sensor data storage unit 208 when it is determined that the number of frames of the acquired first sensor data does not reach the request number of frames, and returns to step 301 to acquire the first sensor data again. In step 303, when the number of frames of the acquired first sensor data reaches the request number of frames, the first pseudo visual field generation unit 203 generates a first pseudo visual field based on a latest acquired frame and the data stored in the sensor data storage unit 208. In step 304, the second sensor data acquisition unit 204 acquires the measurement data from the second sensor 106. In step 305, the transformation matrix calculation unit 205 calculates the transformation matrix for use in aligning the data from the second sensor 106 with the first pseudo visual field generated by the first pseudo visual field generation unit 203. In step 306, the transformation matrix calculation unit 205 determines whether the transformation matrix calculated in step 305 is stored. When it is determined that the transformation matrix is stored, the transformation matrix storage unit 209 stores the transformation matrix in step 307. When it is unnecessary to calculate the transformation matrix again after the alignment is performed once, a calculation load can be reduced by continuously using the transformation matrix stored in the transformation matrix storage unit 209. In step 308, the alignment unit 206 aligns the first sensor data acquired in step 301 and the second sensor data acquired in step 304 using the transformation matrix calculated in step 305. With the alignment, the integrated image obtained by integrating the first sensor data and the second sensor data is generated.

As an algorithm for calculating the transformation matrix in step 305, there are many methods such as a method for detecting a characteristic portion of data called a key point and performing matching, a method using deep learning, and iterative closest points (ICP), but the method in the invention is not particularly limited, and the transformation matrix may be calculated using any method.

The transformation matrix calculated by the transformation matrix calculation unit 205 has different shapes depending on a type of data acquired by the first sensor 104 and the second sensor 106. In a case in which the data acquired by the first sensor 104 and the second sensor 106 is two-dimensional data, an affine transformation is widely known in which coordinates of rotation and translation of an image are converted. When the transformation matrix is expressed by 3×3, and, as an example, when two-dimensional data of x and y coordinates is converted into x′ and y′ coordinates, the calculation can be expressed as the following Formula 1 with a to f as natural numbers.

$$\begin{matrix}Formula 1 & \\ ( \begin{matrix}{x}^{′} \\ {y}^{′} \\ 1\end{matrix} ) = ( \begin{matrix}a & b & c \\ d & e & f \\ 0 & 0 & 1\end{matrix} ) ( \begin{matrix}x \\ y \\ 1\end{matrix} ) & ( 1 )\end{matrix}$$

In a case in which the data acquired by the first sensor 104 and the second sensor 106 is three-dimensional data, and, as an example, three-dimensional data of x, y, and z coordinates is converted into x′, y′, and z′ coordinates, the translation can be expressed as the following Formula 2 when r₁ to r₉ are set to rotation matrix parameters of natural numbers and t₁ to t₃ are set to translation parameters of natural numbers.

$$\begin{matrix}Formula 2 & \\ ( \begin{matrix}{x}^{′} \\ {y}^{′} \\ {z}^{′}\end{matrix} ) = ( \begin{matrix}{r}_{1} & {r}_{2} & {r}_{3} \\ {r}_{4} & {r}_{5} & {r}_{6} \\ {r}_{7} & {r}_{8} & {r}_{9}\end{matrix} ) ( \begin{matrix}x \\ y \\ z\end{matrix} ) + ( \begin{matrix}{t}_{1} \\ {t}_{2} \\ {t}_{3}\end{matrix} ) & ( 2 )\end{matrix}$$

### First Embodiment: Generate Pseudo Visual Field

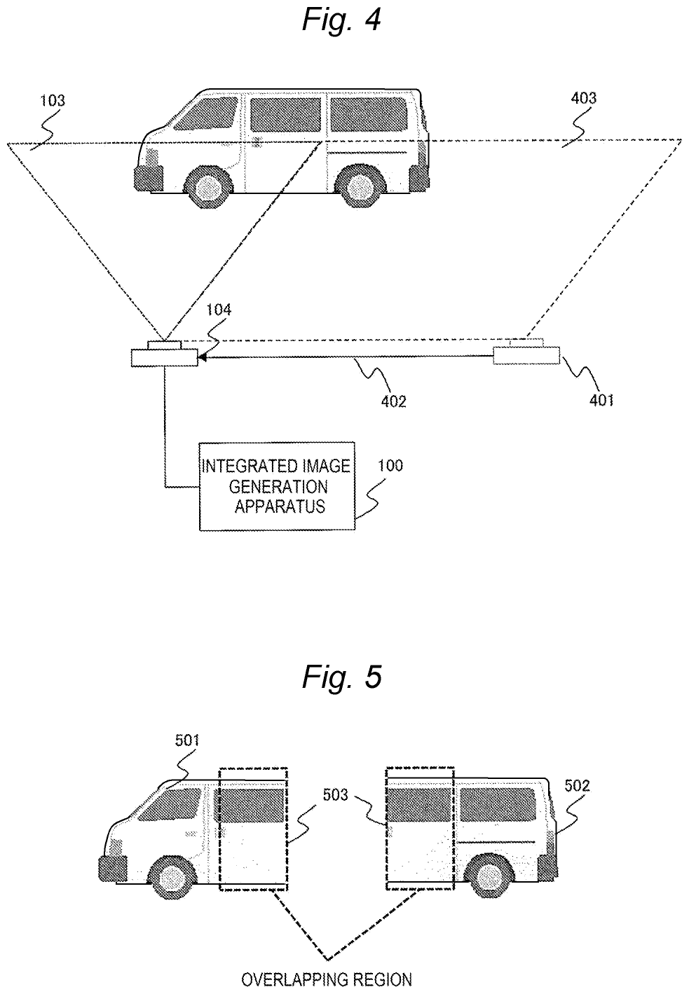

FIG. 4 is a diagram illustrating a procedure in which the first pseudo visual field generation unit 203 generates a pseudo visual field 403. At this time, only the first sensor 104 is considered without considering the second sensor 106. First, the first sensor 104 is installed at a first sensor movement start position 401, and then the first sensor 104 is moved along a first sensor movement path 402 while acquiring data, and is installed at the same position as that of the first sensor 104 as illustrated in FIG. 1. The first pseudo visual field generation unit 203 can generate the pseudo visual field 403 by connecting data acquired during movement of the first sensor 104. As a technique of generating one large visual field based on the data acquired during the movement, a technique called simultaneous localization and mapping (SLAM) is widely developed. Specifically, there are methods such as Visual SLAM implemented when data acquired by the sensor is a two-dimensional color image and Depth SLAM implemented when data acquired by the sensor is distance information. In the invention, appropriate SLAM may be performed in the sensor to be used to generate the pseudo visual field.

The measurement data in the first visual field 103 is constantly updated by the first sensor 104. On the other hand, since the pseudo visual field 403 is generated only during the movement of the first sensor 104, the measurement data is not updated that once acquired. When an update such as a movement of the subject is not performed in the pseudo visual field 403, alignment can be performed between the pseudo visual field 403 and the second visual field 105 by installing the second sensor 106 in the pseudo visual field 403. For example, in a case in which the first sensor 104 and the second sensor 106 are newly installed, since the first sensor 104 can be relatively freely moved, a use mode as illustrated in FIG. 4 can be easily implemented.

FIG. 5 illustrates image data 501 acquired in the first visual field 103 without using the pseudo visual field 403, image data 502 acquired in the second visual field 105, and an overlapping region 503 between the image data 501 and the image data 502. The overlapping region 503 is only a limited part of the visual field.

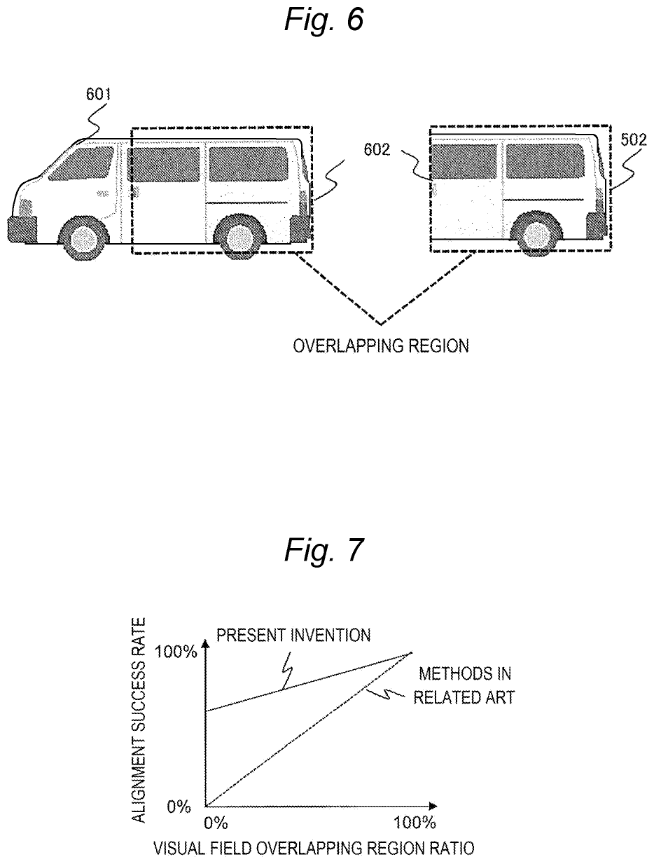

FIG. 6 illustrates image data 601 acquired using the pseudo visual field 403 as illustrated in FIG. 4, the image data 502 acquired in the second visual field 105, and an overlapping region 602 between the image data 601 and the image data 502. Thus, by using the pseudo visual field 403, it is possible to enlarge the visual field overlapping region in a pseudo manner when the first sensor 104 and the second sensor 106 are installed. When the alignment is performed using the visual field overlapping region of the sensors, since a larger overlapping region leads to that a more correct transformation matrix calculated by the transformation matrix calculation unit 205 is obtained generally, a size of the overlapping region is directly linked to accuracy of the alignment. It is also possible to increase the visual field overlapping region by physically reducing a distance between the first sensor 104 and the second sensor 106, but in this case, a total visual field of the first sensor 104 and the second sensor 106 is small.

FIG. 7 is a schematic diagram illustrating a relationship between a visual field overlapping region ratio and an alignment success rate. When the invention is used, the greatest feature is that the alignment success rate is improved compared to methods in the related art while the visual field overlapping region ratio during the installation of the first sensor 104 and the second sensor 106 is small. Even when a plurality of sensors are installed, the alignment success rate can be improved using a simple method by generating only one pseudo visual field and increasing the visual field overlapping region ratio.

In the first embodiment, as illustrated in FIG. 1, the case is described in which the visual field overlapping region is present during the installation of the first sensor 104 and the second sensor 106, but when the alignment is performed using the pseudo visual field, the visual field overlapping region is not necessarily required, and there is no problem in eliminating the visual field overlapping region as long as the pseudo visual field of the first sensor 104 can be generated in a manner of covering the second visual field 105 of the second sensor 106. In the first embodiment, an example in which two sensors are used is illustrated, but the number of sensors is not particularly limited, and the alignment can be performed without any particular problem even though the number of sensors is increased as long as the pseudo visual field can be used for covering.

In the first embodiment, an example is described in which the processing in flowchart in FIG. 3 is executed while acquiring data from the first sensor 104 and the second sensor 106 in real time. Alternatively, the measurement data may be acquired and stored in advance by the first sensor 104 and the second sensor 106 (advance preparation image), and the processing in the same flowchart as that in FIG. 3 may be executed by reading the stored information. Alternatively, data corresponding to the subject 102 may be created by, for example, computer graphics (CG) (advance preparation image). In this case, a step of reading information stored in advance may be added instead of step 301 to step 304. That is, any method can be used as long as a transformation matrix for use in performing alignment may be obtained.

### Second Embodiment

In the first embodiment, a method for only moving the first sensor 104 is described as the method for generating the pseudo visual field. In a second embodiment of the invention, a method for generating a pseudo visual field using a movement of a subject will be described. Since a configuration of the integrated image generation apparatus 100 and configurations of sensors are the same as that according to the first embodiment, a method for generating the pseudo visual field will be mainly described below.

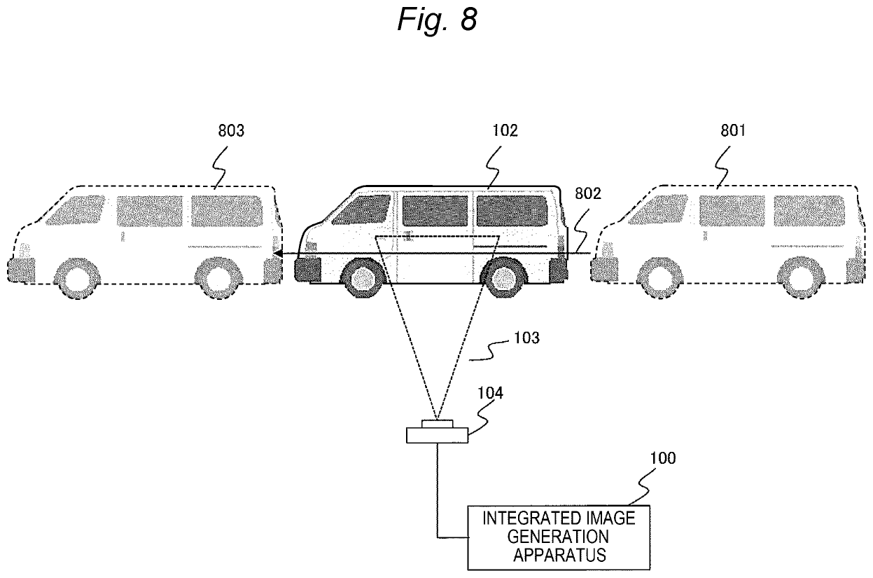

FIG. 8 is a configuration diagram illustrating a method for generating a pseudo visual field according to the second embodiment. When the subject 102 passes through the first visual field 103, the subject 102 moves from a subject movement start position 801 to a subject movement end position 803 along a subject movement path 802. At this time, the first sensor 104 continues to acquire data of the passing subject 102. Here, the acquired data are data that can be spatially connected when the subject 102 moves linearly while acquired acquisition times are different from each other.

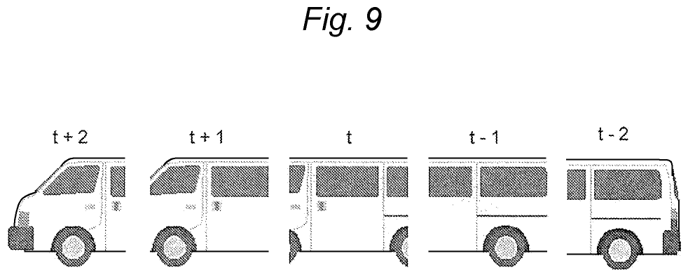

FIG. 9 illustrates an example of data of the subject 102 acquired in previous and next ±2 frames when a time at which the subject 102 passes through a center of the first visual field 103 is set as t. At the time t, data of only a central portion of the subject is acquired, and data of a front portion of the subject is acquired at t+1 and t+2, and data of a rear portion of the subject is acquired at t−1 and t−2. The first pseudo visual field generation unit 203 can generate data of the entire subject as a pseudo visual field by connecting these data. Since it is necessary to generate the pseudo visual field by moving the first sensor 104 in the first embodiment, the alignment can be performed under a condition that the subject is stopped and only when the sensor is installed, and the alignment cannot be performed after the sensor is installed. In the second embodiment, the alignment can be performed again not only when the sensor is installed but also after the sensor is installed, and convenience of the integrated image generation apparatus 100 is improved.

In the second embodiment, since the measurement data acquired by the first sensor 104 are connected at a plurality of times, it is desirable that the subject 102 moves straight without being deformed in the first visual field 103. This is because a positional deviation at the time of connection easily occurs.

### Third Embodiment

In the first and second embodiments, a method for improving the alignment success rate between the first sensor 104 and the second sensor 106 by generating only the pseudo visual field of the first sensor 104 is described. In a third embodiment of the invention, a method for generating a pseudo visual field not only by the first sensor 104 but also by the second sensor 106 and improving a visual field overlapping rate will be described.

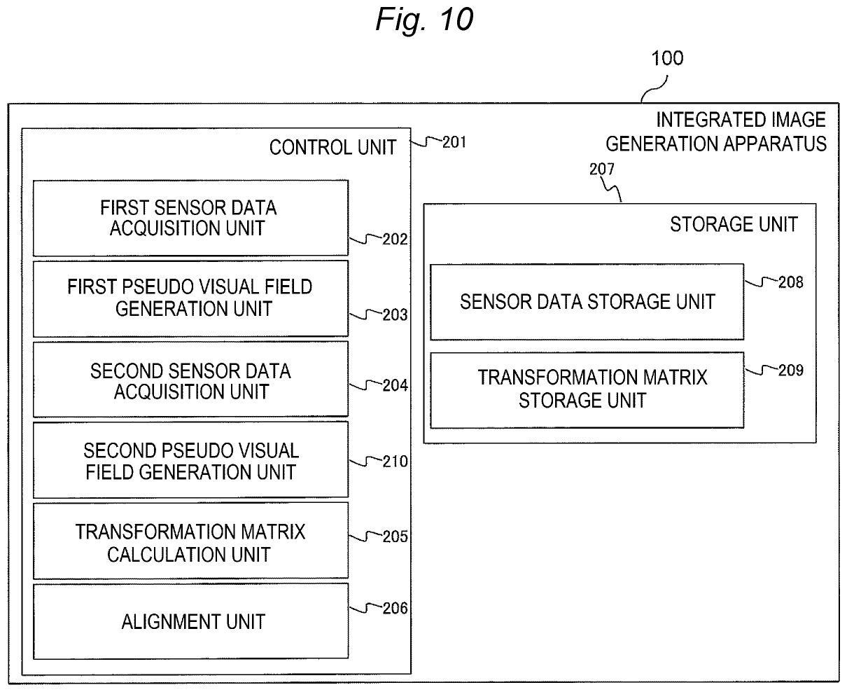

FIG. 10 is a functional block diagram of the integrated image generation apparatus 100 according to the third embodiment. Differences from functional blocks of the integrated image generation apparatus 100 illustrated in FIG. 2 are that a second pseudo visual field generation unit 210 is newly provided, and that the second pseudo visual field generation unit 210 generates a second pseudo visual field using data acquired by the second sensor data acquisition unit 204. A method for generating the second pseudo visual field may be the same as that according to the first embodiment (the first sensor 104 is moved), the same as that according to the second embodiment (the subject 102 is moved), or a combination thereof.

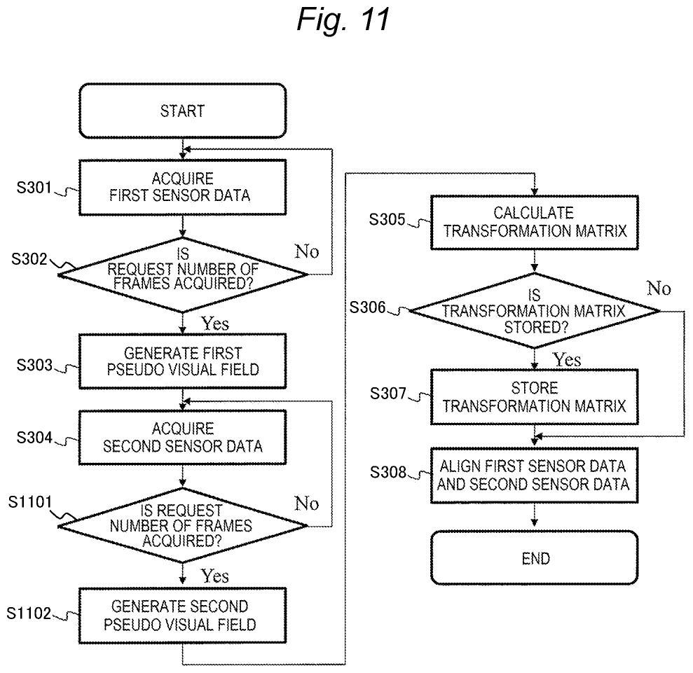

FIG. 11 is a flowchart illustrating a processing procedure performed by the integrated image generation apparatus 100 according to the third embodiment. Differences from the flowchart in FIG. 3 are that it is determined in step 1101 whether the number of acquired frames of second sensor data reaches a request number of frames, and that the second pseudo visual field of the second sensor data is generated in step 1102. In step 305, the transformation matrix calculation unit 205 calculates a transformation matrix using a pseudo visual field generated by data of the first sensor 104 and a pseudo visual field generated by data of the second sensor 106. In order to generate the pseudo visual field, the same processing as processing described in FIG. 3 or FIG. 7 may be executed on the second sensor 106. As described above, since a larger visual field overlapping region of the first sensor 104 and the second sensor 106 leads to that the transformation matrix can be calculated more correctly, an alignment success rate is further improved by using both pseudo visual fields.

### Fourth Embodiment

In the first to third embodiments, a method for accurately aligning a plurality of pieces of data using the pseudo visual field of the first sensor 104 and/or the pseudo visual field of the second sensor 106 is described. In a fourth embodiment of the invention, a method for accurately performing alignment even though an alignment error occurs at the time of generating the pseudo visual field, by performing the alignment using the pseudo visual field and then performing the alignment again using a normal visual field, will be described.

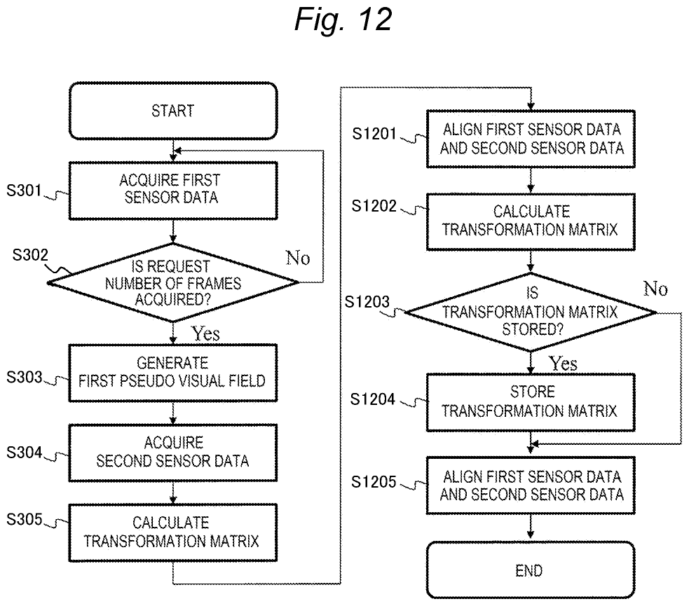

FIG. 12 is a flowchart illustrating processing performed by the integrated image generation apparatus 100 in the fourth embodiment. Processing of steps 301 to 305 are the same as those in FIG. 3. In step 1201, the alignment unit 206 performs alignment using a transformation matrix calculated by the transformation matrix calculation unit 205. In step 1202, the transformation matrix calculation unit 205 calculates the transformation matrix again for data, acquired by the first sensor 104 and the second sensor 106, on which the alignment in step 1201 is performed. The data used at this time is data that can be acquired by normal visual fields of the first sensor 104 and the second sensor 106 without generating pseudo visual fields. In step 1203, the transformation matrix calculation unit 205 determines whether it is necessary to store the recalculated transformation matrix, and when it is necessary to store the recalculated transformation matrix, the transformation matrix calculation unit 205 stores the transformation matrix in the transformation matrix storage unit 209 in step 1204. In step 1205, the alignment unit 206 performs alignment between measurement data of the first sensor 104 and measurement data of the second sensor 106 using the recalculated transformation matrix.

A feature of the fourth embodiment is that the alignment using the pseudo visual fields as described in the first to third embodiments is performed before the alignment is performed using only the normal visual fields of the first sensor 104 and the second sensor 106. When the alignment is performed from a state in which an initial position is close to a certain degree, it is possible to limit a range in which the transformation matrix can be taken and to reduce an error calculation rate of the transformation matrix. Therefore, as compared with the transformation matrix calculation executed in step 305, it is desirable that the transformation matrix calculation executed in step 1202 is configured such that the alignment is performed at a closer position. Thus, by combining rough alignment using the pseudo visual field and accurate alignment using the normal visual field, it is possible to perform the accurate alignment without being influenced by generation accuracy of the pseudo visual field.

### Modification of Invention

The invention is not limited to the embodiments described above, and includes various modifications. For example, the embodiments described above are described in detail for easy understanding of the invention, and the invention is not necessarily limited to those including all the configurations described above. A part of a configuration according to one embodiment can be replaced with a configuration according to another embodiment, and a configuration according to another embodiment can also be added to a configuration according to one embodiment. A part of a configuration according to each embodiment may be added, deleted, or replaced with another configuration.

What is claimed is:

1. An image generation apparatus for generating an image of a subject using image data of the subject acquired by a sensor, the image generation apparatus comprising:
a first data acquisition unit configured to acquire first image data of the subject acquired by a first sensor;
a second data acquisition unit configured to acquire second image data of the subject acquired by a second sensor;
a first pseudo visual field generation unit configured to generate, based on the first image data, first pseudo visual field image data that is able to be acquired by the first sensor in a first pseudo visual field of the first sensor brought about by a change in a relative position between the subject and the first sensor; and
an alignment unit configured to perform alignment between the first pseudo visual field image data and the second image data.

2. The image generation apparatus according to claim 1, wherein
the alignment unit performs the alignment such that coordinate systems of portions of the first pseudo visual field image data and the second image data that overlap each other coincide with each other.

3. The image generation apparatus according to claim 1, wherein
the first pseudo visual field generation unit specifies the first pseudo visual field generated as the first sensor moves and the relative position moves, and
the first pseudo visual field generation unit generates the first pseudo visual field image data using the first image data acquired by the first sensor in the specified first pseudo visual field.

4. The image generation apparatus according to claim 1, wherein
the first pseudo visual field generation unit generates the first pseudo visual field image data such that the first pseudo visual field and a second visual field include a portion overlapping each other even when a first visual field of the first sensor and the second visual field of the second sensor do not overlap each other.

5. The image generation apparatus according to claim 1, wherein
the first pseudo visual field generation unit specifies the first pseudo visual field generated as the subject moves and the relative position moves, and
the first pseudo visual field generation unit generates the first pseudo visual field image data using the first image data acquired by the first sensor in the specified first pseudo visual field.

6. The image generation apparatus according to claim 5, wherein
the first pseudo visual field generation unit generates the first pseudo visual field image data by connecting the first image data acquired by the first sensor at a plurality of sampling time points.

7. The image generation apparatus according to claim 1, further comprising:
a second pseudo visual field generation unit configured to generate, based on the second image data, second pseudo visual field image data that is able to be acquired by the second sensor in a second pseudo visual field of the second sensor brought about by a change in a relative position between the subject and the second sensor, wherein
the alignment unit performs the alignment between the first pseudo visual field image data and the second pseudo visual field image data.

8. The image generation apparatus according to claim 7, wherein
the second pseudo visual field generation unit generates the second pseudo visual field image data based on the second pseudo visual field brought about by a movement of the second sensor or a movement of the subject.

9. The image generation apparatus according to claim 1, wherein
the alignment unit performs first alignment between the first pseudo visual field image data and the second image data, and then performs second alignment between the first image data and the second image data.

10. The image generation apparatus according to claim 9, wherein
the alignment unit performs alignment in a first image region in the first alignment, and
the alignment unit performs alignment in a second image region smaller than the first image region in the second alignment.

11. The image generation apparatus according to claim 1, wherein
the first pseudo visual field generation unit sets an image acquired in advance by the first sensor as an advance preparation image, and generates the first pseudo visual field image data using the advance preparation image instead of or in combination with the first image data.

12. The image generation apparatus according to claim 1, wherein
the first pseudo visual field generation unit sets an image generated in advance as an image acquired by the first sensor as an advance preparation image, and generates the first pseudo visual field image data using the advance preparation image instead of or in combination with the first image data.

13. The image generation apparatus according to claim 1, wherein
the alignment unit generates an integrated image obtained by integrating the first image data and the second image data by performing the alignment between the first pseudo visual field image data and the second image data.

14. An image generation system comprising:
the image generation apparatus according to claim 1;
the first sensor; and
the second sensor.

15. An image generation method for generating an image of a subject by using image data of the subject acquired by a sensor, the image generation method comprising:
a step of acquiring first image data of the subject acquired by a first sensor;
a step of acquiring second image data of the subject acquired by a second sensor;
a step of generating, based on the first image data, first pseudo visual field image data that is able to be acquired by the first sensor in a first pseudo visual field of the first sensor brought about by a change in a relative position between the subject and the first sensor; and
a step of performing alignment between the first pseudo visual field image data and the second image data.
